(19) United States
(12) Patent Application Publication
(10) Pub. No.: US 2025/0370707 A1
(43) Pub. Date: Dec. 4, 2025

(54) WEARABLE AUDIO DEVICE HAVING WHISPER VOICE INPUT

(71) Applicant: BOSE CORPORATION, Framingham, MA (US)

(72) Inventors: Chuan-Che HUANG, Natick, MA (US); Shuo ZHANG, Belmont, MA (US); Qiaoyu YANG, Framingham, MA (US); Mikolaj Aleksander KEGLER, London (GB)

(21) Appl. No.: 18/679,057

(22) Filed: May 30, 2024

(51) Int. Cl. G06F 3/16; H04R 1/08; H04R 1/10; H04R 29/00

(52) U.S. Cl. CPC G06F 3/167; H04R 29/004; H04R 1/08; H04R 1/1008

(57) ABSTRACT

Aspects of the present disclosure provide techniques, including devices and systems implementing the techniques, to discreetly enable a user to perform a desired command or action on the wearable audio output device. In certain aspects, enabling the commands or actions to be performed may involve at least one audio sensor detecting a command from a user, where the command is a whisper or spoken at a volume level of about 50 dB or less, to discreetly enable a desired audio mode. In certain aspects, enabling the commands or actions to be performed may involve at least one ultrasound sensor detecting information capturing movement from at least one of a small joint or ear from a user, where the movement detected correlates to a user whispering.

### FIELD

Aspects of the disclosure generally relate to wearable devices, and, more particularly, to techniques to enable user commands to be performed discreetly on a wearable device.

### BACKGROUND

Wearable audio output devices may provide a user with a desired transmitted or reproduced audio experience by being able to perform hand-free commands or instructions for an enhanced listening experience. Such commands or instructions may include an action, such as controlling volume, transport controls, noise cancelling and/or audio pass through, spatial audio settings, feature activation, changing the connected device(s), VPAs, internet searches, content searches, making a call, and/or responding to texts/messages/emails. For example, the command may be to operate in a specific audio output modes, such as a “work mode” to minimize distractions when a user is working, or a “public mode” to help increase awareness of the user’s surroundings. The various audio output modes and instructions may be voice controlled by a user speaking instructions. However, many users do not like to use such voice control in public or around other people, and a wake word (e.g., “hey headphones”) may be required to enable the voice control function. Furthermore, in wearable audio output devices that require a wake word, the wake word may be difficult to detect in noisy environments, or difficult to differentiate when the user is talking to the wearable audio output device versus speaking to other people. As such, a user may be unlikely to utilize the various beneficial audio modes or convenient hands-free instructions.

Accordingly, methods for discretely enabling audio output modes and hands-free commands of wearable audio output devices, as well as apparatuses and systems configured to implement these methods, are desired.

### SUMMARY

All examples and features mentioned herein can be combined in any technically possible manner.

Aspects of the present disclosure provide techniques, including devices and systems implementing the techniques, to discreetly enable a user to perform a desired command or action on the wearable audio output device. In certain aspects, enabling the commands or actions to be performed may involve at least one audio sensor detecting a command from a user, where the command is a whisper or spoken at a volume level of about 50 dB or less, to discreetly enable a desired audio mode. In certain aspects, enabling the commands or actions to be performed may involve at least one ultrasound sensor detecting information capturing movement from at least one of a small joint or ear from a user, where the movement detected correlates to a user whispering.

Aspects of the present disclosure provide a wearable audio device. The wearable audio device comprises a housing; at least one audio sensor disposed in or on the housing; andat least one processor configured to: receive input from the at least one audio sensor; detect, using the at least one audio sensor, audio from a user of the wearable audio device; and perform an action in response to determining that i) a volume level of the audio from the user of the wearable audio device is below a threshold and ii) the audio indicates a desired performance of the action.

In aspects, the volume level is below a normal speaking volume level of the user.

In aspects, the threshold is at most 50 dB.

In aspects, one or more audio sensors of the at least one audio sensor is a microphone.

In aspects, the microphone is a feedback microphone disposed within the housing.

In aspects, the housing is acoustically coupled with an ear canal of the user to define an acoustic volume, and wherein one or more audio sensors of the at least one audio sensor is included in the acoustic volume.

In aspects, the at least one processor is further configured to extract the user’s audio from other audio sensed.

In aspects, the determination triggers the performance of the action.

In aspects, the audio from the user is a whisper.

In aspects, determining that the volume level of the audio from the user of the wearable audio device is below the threshold comprises determining that the characteristics of the audio is whisper speech.

Aspects of the present disclosure provide a method for covertly enabling various audio modes. The method includes receiving input from at least one audio sensor of a wearable audio device; detecting, using the at least one audio sensor, audio from a user of the wearable audio device; and performing an action in response to determining that i) a volume level of the audio from the user of the wearable audio device is below a threshold and ii) the audio indicates a desired performance of the action.

In aspects, the audio from the user is a whisper.

In aspects, the threshold is at most 50 dB.

In aspects, one or more audio sensors of the at least one audio sensor is a microphone.

In aspects, the microphone is a feedback microphone disposed within a housing.

In aspects, the housing is acoustically coupled with an ear canal of the user to define an acoustic volume, and wherein one or more audio sensors of the at least one audio sensor is included in the acoustic volume.

In aspects, the at least one processor is further configured to extract the user’s audio from other audio sensed.

In aspects, the determination triggers the performance of the action.

In aspects, determining that the volume level of the audio from the user of the wearable audio device is below the threshold comprises determining that the characteristics of the audio is whisper speech.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2A illustrates an exemplary wireless audio device, in which aspects of the present disclosure may be implemented.

FIG. 2B illustrates an exemplary computing device, in which aspects of the present disclosure may be implemented.

FIG. 3 illustrates example operations performed by a wearable device worn by a user for discreetly selecting an audio mode or performing a command, according to certain aspects of the present disclosure.

FIGS. 4A-4B illustrates example operations, respectively, performed by a wearable device worn by a user for detecting audio using at least one audio sensor of the wearable device, according to certain aspects of the present disclosure.

Like numerals indicate like elements.

### DETAILED DESCRIPTION

Certain aspects of the present disclosure provide techniques, including devices and system implementing the techniques, for enabling audio modes or performing hands-free commands or instructions of a wearable device without utilizing a wake word. The audio mode enablement may involve at least one audio sensor detecting a command from a user, where the command is a whisper or spoken at a volume level of about 50 dB or less, to discreetly enable a desired audio mode or to perform a desired command.

Wearable audio output devices help users enjoy a customized listening experiences based on a desired audio output mode or by performing convenient hands-free commands or instructions. However, to enable an audio output mode or to perform a hands-free commands with voice control, users often have to say a wake word to alert the wearable audio output device that the user has a command for the wearable audio output device. The requirement of a wake word presents several challenges. For example, the wake word can be difficult for the wearable audio output device to detect in noisy environments, the wake word may be difficult to differentiate from normal conversation, and users may prefer not to use a wake word in public. As such, users may choose not to enable their desired audio output mode or to perform their desired command, resulting in a decreased listening experience.

The present disclosure may enable the wearable device of a user to discreetly select a desired audio mode or to perform a command without utilizing a wake word. As a result, the user may be able to maximize their audio experience by covertly switching between desired audio modes or performing desired commands.

### AN EXAMPLE SYSTEM

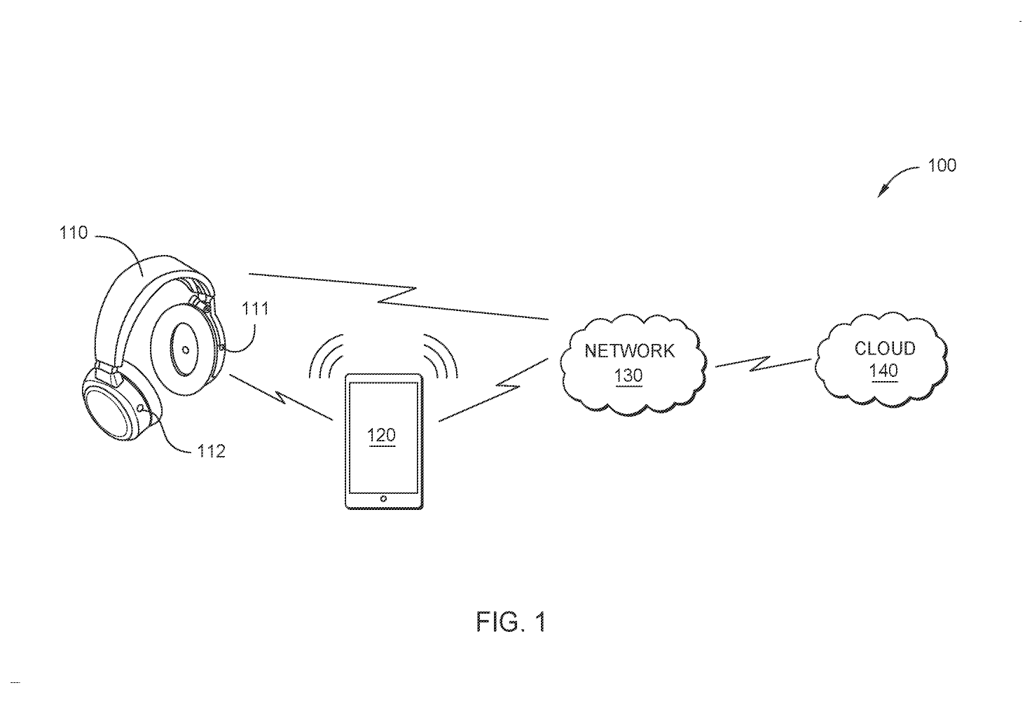

FIG. 1 illustrates an example system 100, in which aspects of the present disclosure are practiced. As shown, system 100 includes a wearable device 110 communicatively coupled with a computing device 120. The wearable device 110 may be configured to be worn by a user, and may be a headset that includes two or more speakers and two or more microphones, as illustrated in FIG. 1. The computing device 120 is illustrated as a smartphone or a tablet computer wirelessly paired with the wearable device 110. At a high level, the wearable device 110 may play audio content transmitted from the computing device 120. The user may use the graphical user interface (GUI) on the computing device 120 to select the audio content and/or adjust settings of the wearable device 110. The wearable device 110 provides soundproofing, active noise cancellation, and/or other audio enhancement features to play the audio content transmitted from the computing device 120. According to aspects of the present disclosure, upon the determining of an event (e.g., measuring a sound and/or detecting an action), the wearable device 110 and/or the computing device 120 may facilitate the awareness of the user by taking one or more actions. The one or more actions may include, for example, decreasing an audio volume of the wearable device 110, decreasing a noise cancellation of the wearable device 110, increasing a transparency of the wearable device 110, pausing an audio output of the wearable device 110, or outputting a notification sound from the wearable device 110.

In certain aspects, the wearable device 110 includes at least two microphones 111 and 112 to capture ambient sound. The captured sound may be used for active noise cancellation and/or event detection. For example, the microphones 111 and 112 may be positioned on opposite sides of the wearable device 110, as illustrated.

In certain aspects, the wearable device 110 includes voice activity detection (VAD) circuitry capable of detecting the presence of speech signals (e.g., human speech signals) in a sound signal received by the microphones 111, 112 of the wearable device 110. For instance, the microphones 111, 112 of the wearable device 110 can receive ambient and external sounds in the vicinity of the wearable device 110, including speech uttered by the user. The sound signal received by the microphones 111, 112 may have the speech signal mixed in with other sounds in the vicinity of the wearable device 110. Using the VAD, the wearable device 110 may detect and extract the speech signal from the received sound signal. In certain aspects, the VAD circuitry may be used to detect and extract speech uttered by the user in order to facilitate a voice call, voice chat between the user and another person, or voice commands for a virtual personal assistant (VPA), such as a cloud based VPA. In some cases, detections or triggers can include self-VAD (only starting up when the user is speaking, regardless of whether others in the area are speaking), active transport (sounds captured from transportation systems), head gestures, buttons, computing device based triggers (e.g., pause/un-pause from the phone), changes with input audio level, and/or audible changes in environment, among others. The voice activity detection circuitry may run or assist running the activity detection algorithm disclosed herein.

In certain aspects, the wearable device 110 includes speaker identification circuitry capable of detecting an identity of a speaker to which a detected speech signal relates to. For example, the speaker identification circuitry may analyze one or more characteristics of a speech signal detected by the VAD circuitry and determine that the user of the wearable device 110 is the speaker. In certain aspects, the speaker identification circuitry may use any of the existing speaker recognition methods and related systems to perform the speaker recognition.

The wearable device 110 further includes hardware and circuitry including processor(s)/processing system and memory configured to implement one or more sound management capabilities or other capabilities including, but not limited to, noise canceling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the wearable device 110 by using active noise cancelling (also known as active noise reduction). The sound masking circuitry is configured to reduce distractions by playing masking sounds via the speakers of the wearable device 110. The movement detecting circuitry is configured to use devices/sensors such as an accelerometer, gyroscope, magnetometer, or the like to detect whether the user wearing the wearable device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In an aspect, the wearable device 110 is wirelessly connected to the computing device 120 using one or more wireless communication methods including, but not limited to, Bluetooth, Wi-Fi, Bluetooth Low Energy (BLE), other radio frequency (RF) based techniques, or the like. In certain aspects, the wearable device 110 includes a transceiver that transmits and receives data via one or more antennae in order to exchange audio data and other information with the computing device 120.

In an aspect, the wearable device 110 includes communication circuitry capable of transmitting and receiving audio data and other information from the computing device 120. The wearable device 110 also includes an incoming audio buffer, such as a render buffer, that buffers at least a portion of an incoming audio signal (e.g., audio packets) in order to allow time for retransmissions of any missed or dropped data packets from the computing device 120. For example, when the wearable device 110 receives Bluetooth transmissions from the computing device 120, the communication circuitry typically buffers at least a portion of the incoming audio data in the render buffer before the audio is actually rendered and output as audio to at least one of the transducers (e.g., audio speakers) of the wearable device 110. This is done to ensure that even if there are RF collisions that cause audio packets to be lost during transmission, there is time for the lost audio packets to be retransmitted by the computing device 120 before the lost audio packets have been rendered by the wearable device 110 for output by one or more acoustic transducers of the wearable device 110.

The wearable device 110 is illustrated as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, or eyeglasses.

In certain aspects, the wearable device 110 is connected to the computing device 120 using a wired connection, with or without a corresponding wireless connection. The computing device 120 may be a smartphone, a tablet computer, a laptop computer, a digital camera, or other computing device that connects with the wearable device 110. As shown, the computing device 120 can be connected to a network 130 (e.g., the Internet) and may access one or more services over the network. As shown, these services can include one or more cloud services 140.

In certain aspects, the computing device 120 can access a cloud server in the cloud 140 over the network 130 using a mobile web browser or a local software application or “app” executed on the computing device 120. In certain aspects, the software application or “app” is a local application that is installed and runs locally on the computing device 120. In certain aspects, a cloud server accessible on the cloud 140 includes one or more cloud applications that are run on the cloud server. The cloud application may be accessed and run by the computing device 120. For example, the cloud application can generate web pages that are rendered by the mobile web browser on the computing device 120. In certain aspects, a mobile software application installed on the computing device 120 or a cloud application installed on a cloud server, individually or in combination, may be used to implement the techniques for low latency Bluetooth communication between the computing device 120 and the wearable device 110 in accordance with aspects of the present disclosure. In certain aspects, examples of the local software application and the cloud application include a gaming application, an audio AR or VR application, and/or a gaming application with audio AR or VR capabilities. The computing device 120 may receive signals (e.g., data and controls) from the wearable device 110 and send signals to the wearable device 110.

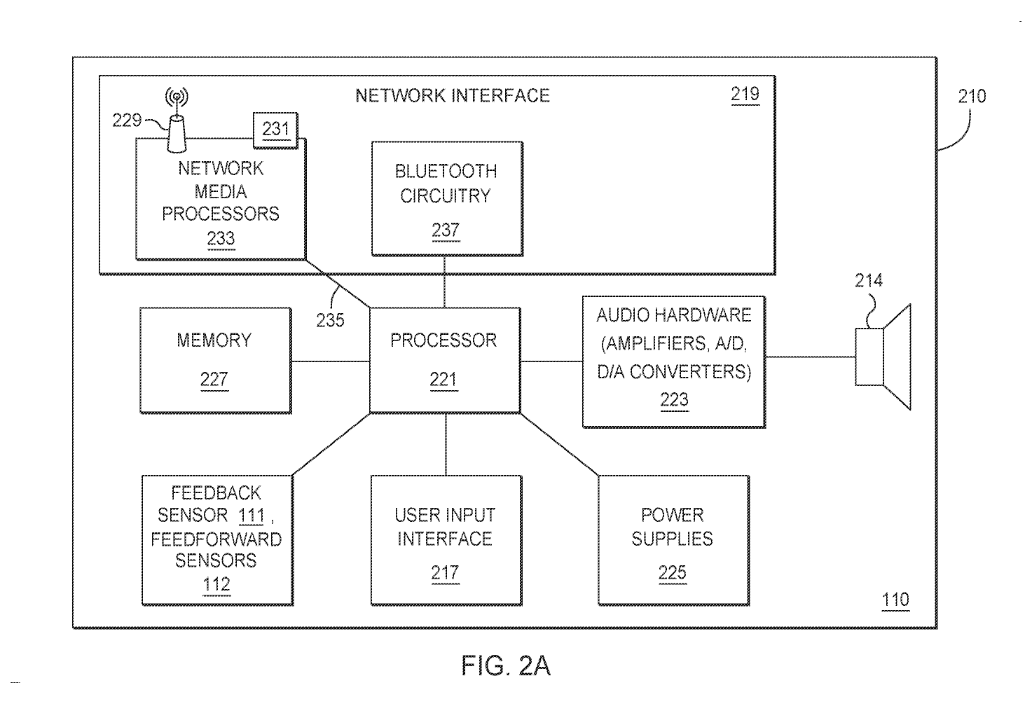

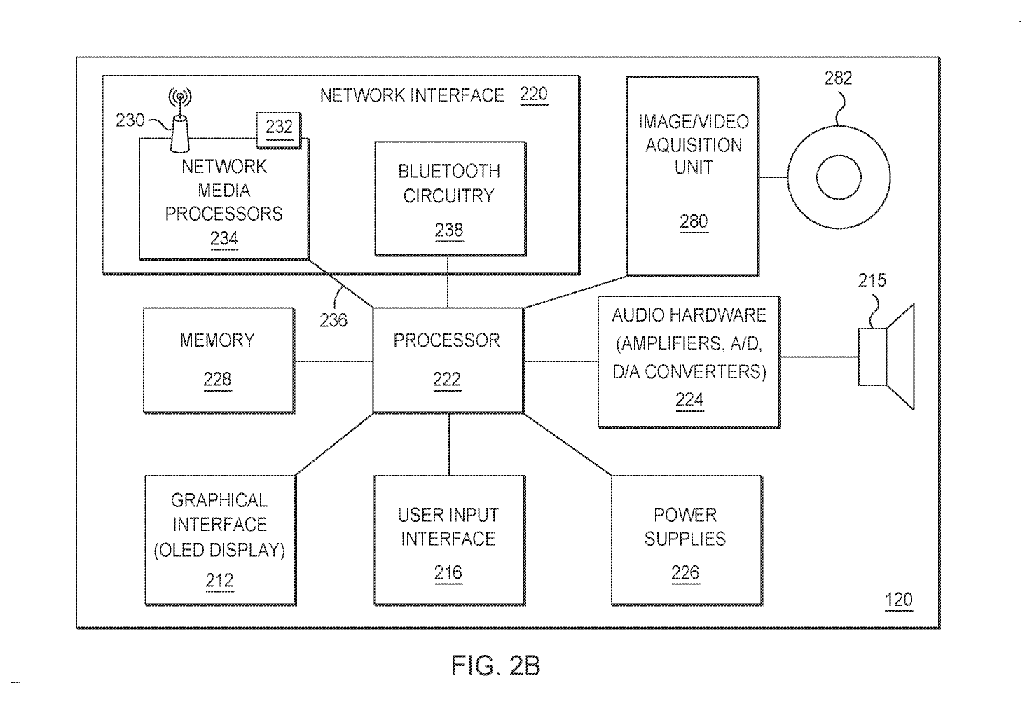

FIG. 2A illustrates an exemplary wearable device 110 and some of its components. Other components may be inherent in the wearable device 110 and not shown in FIG. 2A. For example, the wearable device 110 may include an enclosure 210 that houses an optional graphical interface (e.g., an OLED display) which can provide the user with information regarding currently playing (“Now Playing”) music.

The wearable device 110 includes one or more electro-acoustic transducers (or speakers) 214 for outputting audio. The wearable device 110 also includes a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single wearable device 110 may provide for single press access to various different digital audio sources.

The wearable device 110 may include a feedback sensor 111 and feedforward sensors 112. The feedback sensor 111 and feedforward sensors 112 may include two or more microphones (e.g., microphones 111, 112 as illustrated in FIG. 1) for capturing ambient sound and provide audio signals for determining location attributes of events. For example, the feedback sensor 111 may provide a mechanism for determining transmission delays between the computing device 120 and the wearable device 110. The transmission delays may be used to reduce errors in subsequent computation. The feedback sensor 111 may provide two or more channels of audio signals. The audio signals are captured by microphones that are spaced apart and may have different directional responses. The two or more channels of audio signals may be used for calculating directional attributes of an event of interest.

As shown in FIG. 2A, the wearable device 110 includes an acoustic driver or speaker 214 to transduce audio signals to acoustic energy through audio hardware 223. The wearable device 110 also includes a network interface 219, at least one processor 221, the audio hardware 223, power supplies 225 for powering the various components of the wearable device 110, and memory 227. In certain aspects, the processor 221, the network interface 219, the audio hardware 223, the power supplies 225, and the memory 227 are interconnected using various buses 235, and several of the components can be mounted on a common motherboard or in other manners as appropriate.

The network interface 219 provides for communication between the wearable device 110 and other electronic computing devices via one or more communications protocols. The network interface 219 provides either or both of a wireless network interface 229 and a wired interface 231. The wireless interface 229 allows the wearable device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the wearable device 110 is not worn by a user. Although illustrated, the wired interface 231 is optional.

In certain aspects, the network interface 219 includes a network media processor 233 for supporting Apple AirPlay^{®} and/or Apple Airplay^{®}2. For example, if a user connects an AirPlay^{®} or Apple Airplay^{®}2 enabled device, such as an iPhone or iPad device, to the network, the user can then stream music to the network connected audio playback devices via Apple AirPlay^{®} or Apple Airplay^{®}2. Notably, the audio playback device can support audio-streaming via AirPlay^{®}, Apple Airplay^{®}2 and/or Digital Living Network Alliance’s (DLNA) Universal Plug and Play (UPnP) protocols, all integrated within one device.

All other digital audio received as part of network packets may pass straight from the network media processor 233 through a USB bridge (not shown) to the processor 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In some aspects, the Bluetooth circuitry 237 may be the primary network interface 219 due to energy constraints. For example, the network interface 219 may use the Bluetooth circuitry 237 solely for mobile applications when the wearable device 110 adopts any wearable form. For example, BLE technologies may be used in the wearable device 110 to extend battery life, reduce package weight, and provide high quality performance without other backup or alternative network interfaces.

In certain aspects, the network interface 219 supports communication with other devices using multiple communication protocols simultaneously at one time. For instance, the wearable device 110 can support Wi-Fi/Bluetooth coexistence and can support simultaneous communication using both Wi-Fi and Bluetooth protocols at one time. For example, the wearable device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor 221. The processor 221 may execute instructions (e.g., for performing, among other things, digital signal processing, decoding, and equalization functions), including instructions stored in the memory 227. The processor 221 may be implemented as a chipset of chips that includes separate and multiple analog and digital processors. The processor 221 may provide, for example, for coordination of other components of the audio wearable device 110, such as control of user interfaces.

The processor 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random access memory (NVRAM). In some aspects, instructions (e.g., software) are stored in an information carrier. The instructions, when executed by one or more processing devices (e.g., the processor 221), perform one or more processes, such as those described elsewhere herein. The instructions can also be stored by one or more storage devices, such as one or more computer or machine-readable mediums (for example, the memory 227, or memory on the processor). The instructions can include instructions for performing decoding (i.e., the software modules include the audio codecs for decoding the digital audio streams), as well as digital signal processing and equalization. In certain aspects, the memory 227 and the processor 221 may collaborate in data acquisition and real time processing with the feedback microphone 111 and feedforward microphones 112.

FIG. 2B illustrates an exemplary computing device 120, such as a smartphone or a mobile computing device, in accordance with certain aspects of the present disclosure. Some components of the computing device 120 may be inherent and not shown in FIG. 2B. For example, the computing device 120 may include an enclosure. The enclosure may house an optional graphical interface 212 (e.g., an organic light-emitting diode (OLED) display), as shown. The graphical interface 212 provides the user with information regarding currently playing (“Now Playing”) music or video. The computing device 120 includes one or more electro-acoustic transducers 215 for outputting audio. The computing device 120 may also include a user input interface 216 that enables user input.

The computing device 120 also includes a network interface 220, at least one processor 222, audio hardware 224, power supplies 226 for powering the various components of the computing device 120, and a memory 228. In certain aspects, the processor 222, the graphical interface 212, the network interface 220, the audio hardware 224, the one or more power supplies 226, and the memory 228 are interconnected using various buses 236, and several of the components can be mounted on a common motherboard or in other manners as appropriate. In some aspects, the processor 222 of the computing device 120 is more powerful in terms of computation capacity than the processor 221 of the wearable device 110. Such difference may be due to constraints of weight, power supplies, and other requirements. Similarly, the power supplies 226 of the computing device 120 may be of a greater capacity and heavier than the power supplies 225 of the wearable device 110.

The network interface 220 provides for communication between the computing device 120 and the wearable device 110, as well as other audio sources and other wireless speaker packages including one or more networked wireless speaker packages and other audio playback devices via one or more communications protocols. The network interface 220 can provide either or both of a wireless interface 230 and a wired interface 232. The wireless interface 230 allows the computing device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include a network media processor 234 and Bluetooth circuity 238, similar to the network media processor 233 and Bluetooth circuity 237 in the wearable device 110 in FIG. 2A. Further, in aspects, the network interface 220 supports communication with other devices using multiple communication protocols simultaneously at one time, as described with respect to the network interface 219 in FIG. 2A.

All other digital audio received as part of network packets comes straight from the network media processor 234 through a bus 236 (e.g., universal serial bus (USB) bridge) to the processor 222 and runs into the decoders, DSP, and eventually is played back (rendered) via the electro-acoustic transducer(s) 215.

The computing device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, FHD videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the wearable device 110, may pass from the network interface 220 to the processor 222. The processor 222 executes instructions within the wireless speaker package (e.g., for performing, among other things, digital signal processing, decoding, and equalization functions), including instructions stored in the memory 228. The processor 222 can be implemented as a chipset of chips that includes separate and multiple analog and digital processors. The processor 222 can provide, for example, for coordination of other components of the audio computing device 120, such as control of user interfaces and applications. The processor 222 provides a processed digital audio signal to the audio hardware 224 similar to the respective operation by the processor 221 described in FIG. 2A.

The memory 228 can include, for example, flash memory and/or non-volatile random access memory (NVRAM). In certain aspects, instructions (e.g., software) are stored in an information carrier. The instructions, when executed by one or more processing devices (e.g., the processor 222), perform one or more processes, such as those described herein. The instructions can also be stored by one or more storage devices, such as one or more computer or machine-readable mediums (for example, the memory 228, or memory on the processor 222). The instructions can include instructions for performing decoding (i.e., the software modules include the audio codecs for decoding the digital audio streams), as well as digital signal processing and equalization.

### Example Operations for Discreet Audio Commands

Aspects of the present disclosure provide techniques, including devices and system implementing the techniques, for enabling commands or actions to be performed on a wearable device without utilizing a wake word. In certain aspects, enabling the commands or actions to be performed may involve at least one audio sensor detecting a command from a user, where the command is a whisper or spoken at a volume level of about 50 dB or less, to discreetly enable a desired audio mode. In certain aspects, enabling the commands or actions to be performed may involve at least one ultrasound sensor detecting information capturing movement from at least one of a small joint or ear from a user, where the movement detected correlates to a user whispering.

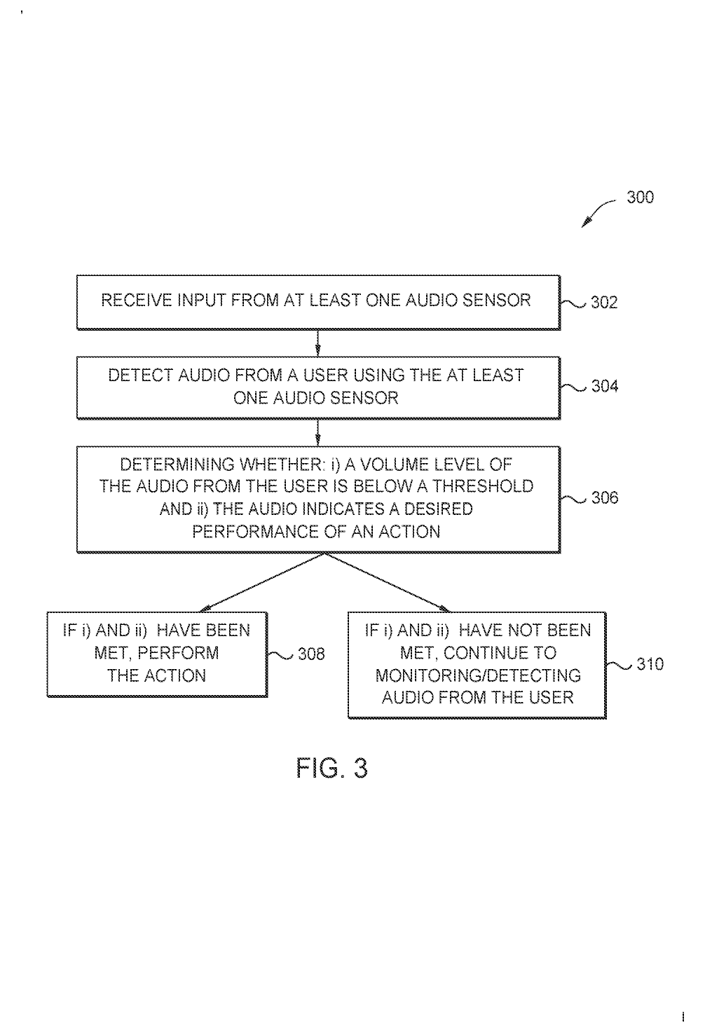

FIG. 3 illustrates example operations 300 performed by a wearable device (e.g., the wearable device 110 of FIGS. 1-2A) worn by a user for discreetly selecting an audio mode or performing a command, according to certain aspects of the present disclosure.

The operations 300 may generally include, at block 302, receiving input from at least one audio sensor. In certain aspects, the input may be a user speaking at a normal volume level (i.e., above about 50 dB, such as about 60 dB), the user speaking in a whisper (i.e., about 50 dB or less, such as about 30 dB), a non-speech vocalization (e.g., sneezing, crying, laughing) measured by the at least one audio sensor, an environmental sound (e.g., other ambient noises and/or nearby voice) measured by the at least one audio sensor, or a user action (e.g., user turning their head or reacting in some manner to the event) detected by the one or more audio sensors. The at least one audio sensor may be a feedback microphone (e.g., a microphone disposed within a housing, such as the enclosure 210 of FIG. 2A, of the wearable device, such as the microphone 111 of FIG. 2A) or an external microphone. In certain aspects, the at least one audio sensor comprises one or more feedback sensors. In other aspects, the at least one audio sensor comprises one or more feedback microphones and one or more external microphones. One or more feedback microphones may be utilized within the at least one audio sensor because feedback microphones are able to detect low volume noises (e.g., whispers) from a user in loud environments.

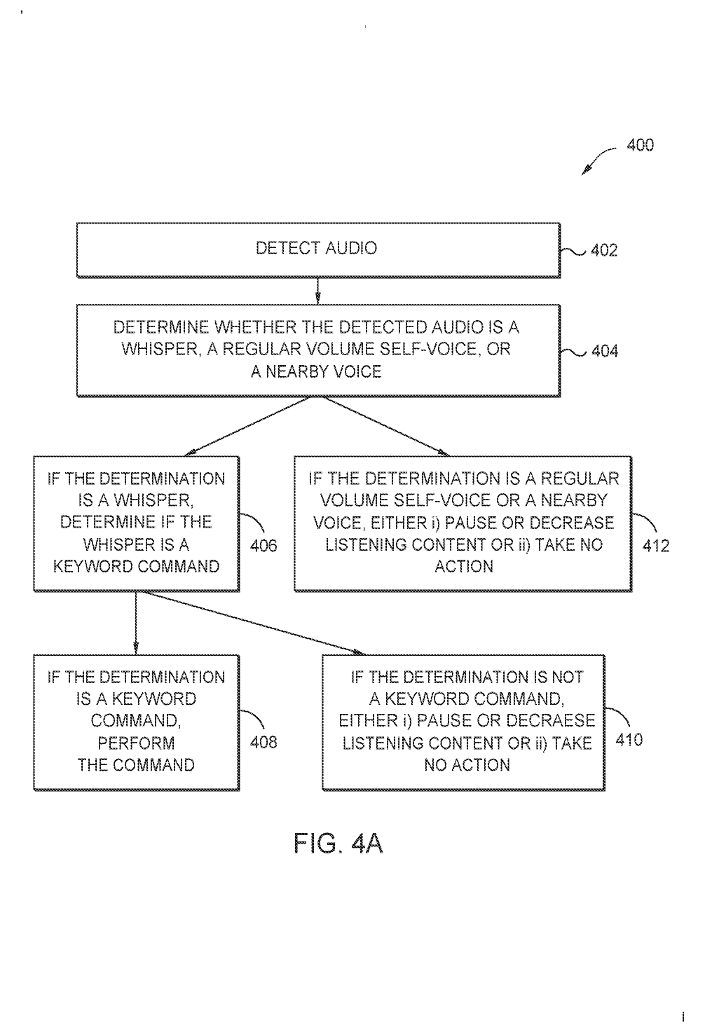

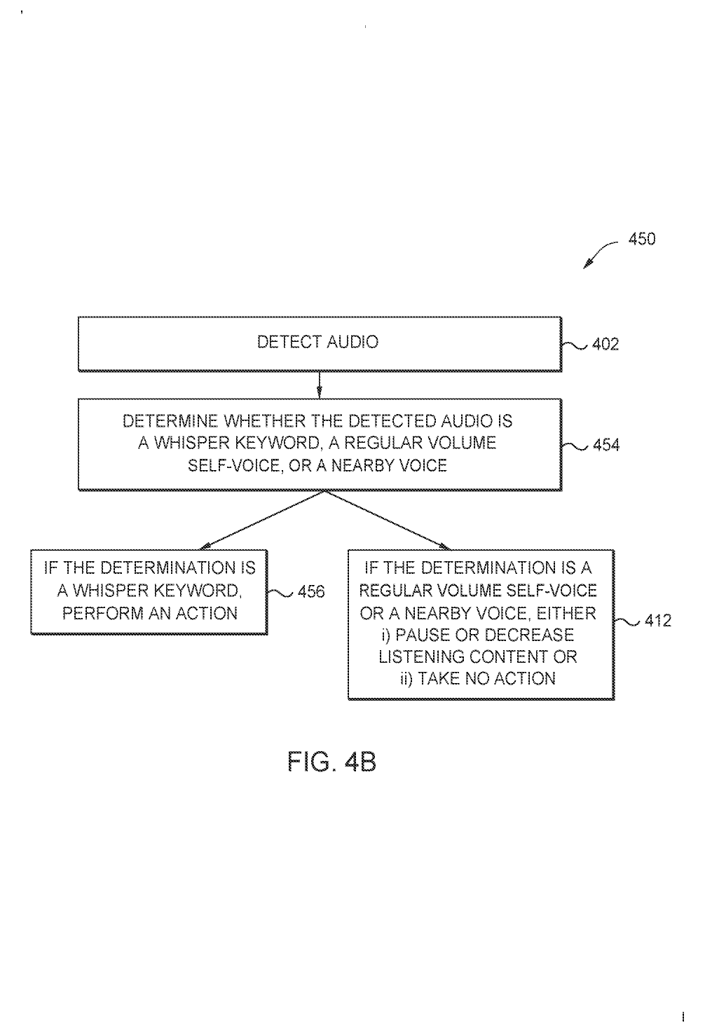

According to certain aspects, the operations 300 may further include, at block 304, detecting audio from the user using the at least one audio sensor and at least one processor, such as the processor 221 of FIG. 2A. In certain aspects, one or more feedback microphones detect the user’s audio. In certain aspects, the audio may be detected to be below a volume threshold, such as about 50 dB or less. The audio may be detected from a distance of about 1 meter or less from the user’s mouth. In other aspects, the audio detected may be a command from the user. In yet other aspects, block 304 and block 306 may be performed simultaneously, or in combination with one another. The at least one processor of the wearable device may be configured to extract the user’s audio from other audio sensed at block 304. Further details on detecting the audio are discussed in FIGS. 4A-4B below.

In certain aspects, a self-VAD (voice activity detector) could be used to help distinguish that the audio is from the user at block 304. Other techniques could also be used, such as determining when at least a portion of the audio is from the user by analyzing all of the sensed audio. This might use a DL/ML-trained model. This might also include an extraction step that extracts the user’s audio from the other audio in the total audio sensed.

According to certain aspects, the operations 300 may further include, at block 306, the at least one processor of the wearable device determines whether: i) a volume level of the audio from the user is below a threshold; and ii) the audio indicates a desired performance of an action. The determination of i) and ii) may occur simultaneously. In certain aspects, the determination of i) may occur before the determination of ii). In other aspects, the determination of ii) may occur before the determination of i). As noted above, in yet other aspects, the determination of i) and/or ii) may occur at block 304. In certain aspects, the volume level of the audio is below a normal speaking volume of the user. In other aspects, the threshold is at most about 50 dB, such as between about 25 dB and 40 dB. In some aspects, determining the volume level of the audio from the user is below a threshold comprises determining that the characteristics of the audio is whisper speech, or that the frequency content of the audio is whisper speech. In certain aspects, a housing of the wearable device is acoustically coupled with an ear canal of the user to define an acoustic volume, and one or more audio sensors of the at least one audio sensor is included in the acoustic volume. In other aspects, the user may train the wearable device to detect the user’s specific whisper.

According to certain aspects, if both i) and ii) are determined at block 306, the operations 300 may further include, at block 308, performing the action. In certain embodiments, the determination at block 306 triggers the performance of the action. The action may be a command or instruction the user desired to occur. For example, the action may be to enter a desired audio mode. Such audio output modes may include “work mode” to minimize distractions when a user is working, or “public mode” to help increase awareness of the user’s surroundings. In certain aspects, the action may be controlling volume, transport controls, noise cancelling and/or audio pass through, spatial audio settings, feature activation, changing the connected device(s), VPAs, internet searches, content searches, making a call, and/or responding to texts/messages/emails. The commands or instructions and the audio modes referred to herein are merely examples or actions that may be performed, and are not intended to be limiting. Upon performing the action, in certain embodiments, the operations 300 being again at block 302.

According to certain aspects, if both i) and ii) are not determined at block 306, the operations 300 may further include, at block 310, to continue monitoring/detecting input or audio from the user. If at least one of i) and ii) are not determined, the methods 300 proceed to block 310. For example, if the user states a command in a normal speaking voice (i.e., a volume level greater than about 50 dB), the operations 300 proceed to block 310, rather than to block 308.

FIGS. 4A-4B illustrates example operations 400, 450, respectively, performed by a wearable device (e.g., the wearable device 110 of FIGS. 1-2B) worn by a user for detecting audio using at least one audio sensor of the wearable device, according to certain aspects of the present disclosure. Operations 400 and 450 may each individually be used in combination with operation 300 of FIG. 3. In certain aspects, operations 400 and 450 may each be individually utilized with blocks 306 and/or block 308 of operations 300 of FIG. 3.

The operations 400 of FIG. 4A may generally include, at block 402, audio is detected by the at least one audio sensor. In certain aspects, the input may be a user speaking at a normal volume level (i.e., above about 50 dB, such as about 60 dB or greater), the user speaking in a whisper (i.e., about 50 dB or less, such as about 30 dB), a non-speech vocalization (e.g., sneezing, crying, laughing) measured by the at least one audio sensor, an environmental sound (e.g., other ambient noises and/or nearby voice) measured by the at least one audio sensor, or a user action (e.g., user turning their head or reacting in some manner to the event) detected by the one or more audio sensors. The at least one audio sensor may be a feedback microphone (e.g., microphones 111, 112) or an external microphone. In certain aspects, the at least one audio sensor comprises one or more feedback sensors. In other aspects, the at least one audio sensor comprises one or more feedback microphones and one or more external microphones. One or more feedback microphones may be utilized within the at least one audio sensor because feedback microphones are able to detect low volume noises (e.g., whispers) from a user in loud environments.

According to certain aspects, the operations 400 may further include, at block 404, determining, using the at least one processor, whether the detected audio is a whisper, a regular volume self-voice of the user, or a nearby voice. In certain aspects, the at least one processor comprises a sound separator processor. The sound separator processor may differentiate the whisper, the regular volume self-voice, and a nearby voice. The sound separator processor may be capable of distinguishing between differentiate the whisper, the regular volume self-voice, and a nearby voice. The whisper may be a volume level of less than about 50 dB, such as about 20 dB to about 40 dB. The whisper may be detected from a distance of about 1 meter or less from the user’s mouth. The regular volume self-voice and the nearby voice may be a volume level of greater than about 50 dB, such as about 50 dB to about 90 dB. According to certain aspects, if at block 404, the determination is that the audio is a whisper, the operations 400 may further proceed to block 406. According to certain aspects, if at block 404, the determination is that the audio is a normal volume self-voice or a nearby voice, the operations 400 may further proceed to block 412.

According to certain aspects, if at block 404, the determination is that the audio is a whisper, the operations 400 may further include, at block 406, determining whether the whisper is a keyword command (e.g., action) using the at least one processor. A keyword command is a command or instruction for the wearable device to perform a specific action. In certain embodiments, the at least one processor comprises a speech or command processor. The speech or command processor may be utilized to determine whether the whisper is a whispered speech, such as a whispered conversation, or a whispered keyword command, such as a command to enter an audio mode or change the volume of the audio output. According to certain aspects, if at block 406, the determination is that the whisper is a keyword command, the operations 400 may further proceed to block 408. According to certain aspects, if at block 406, the determination is that the whisper is not a keyword command, the operations 400 may further proceed to block 410.

According to certain aspects, if at block 406, the determination is that the whisper is a keyword command, the operations 400 may further include, at block 408, performing the keyword command or action using the at least one processor. In certain embodiments, the determination at block 406 triggers the performance of the keyword command. The action may be a command or instruction the user desired to occur. For example, the action may be to enter a desired audio mode. Such audio output modes may include “work mode” to minimize distractions when a user is working, or “public mode” to help increase awareness of the user’s surroundings. In certain aspects, the action may be controlling volume, transport controls, noise cancelling and/or audio pass through, spatial audio settings, feature activation, changing the connected device(s), VPAs, internet searches, content searches, making a call, and/or responding to texts/messages/emails. The commands or instructions and the audio modes referred to herein are merely examples or actions that may be performed, and are not intended to be limiting. Upon performing the action, in certain embodiments, the operations 400 being again at block 402.

According to certain aspects, if at block 406, the determination is that the whisper is not a keyword command, the operations 400 may further include, at block 410, to either i) pause or decrease the listening content, or ii) to take no immediate action. The at least one processor may be configured to perform either i) or ii) based on a user’s input preferences. Aspects where the listening content is paused or decreased may relate to managing ambient noise, such as when the user wishes to converse with another person. Examples of management of ambient noise is described in co-pending patent application titled “Ambient Noise Management To Facilitate User Awareness And Interaction,” United States App. No. 18/356,976, filed July 21, 2023, assigned to the same assignee of this application, which is herein incorporated by reference. Upon performing the either i) or ii), in certain embodiments, the operations 400 being again at block 402.

According to certain aspects, if at block 404, the determination is that the audio is a normal volume self-voice or a nearby voice, the operations 400 may further include, at block 412 to either i) pause or decrease the listening content, or ii) to take no immediate action. The at least one processor may be configured to perform either i) or ii) based on a user’s input preferences. Upon performing the either i) or ii), in certain embodiments, the operations 400 being again at block 402.

The operations 450 of FIG. 4B are similar to the operations 400 of FIG. 4A. The operations 450 may generally include the block 402, where audio is detected by the at least one audio sensor.

According to certain aspects, the operations 450 may further include, at block 454, determining, using the at least one processor, whether the detected audio is a whisper keyword, a regular volume self-voice of the user, or a nearby voice. The whisper keyword is a command or instruction to the wearable device spoken in a whisper or below a user’s normal speaking voice (i.e., less than about 50 dB, such as about 20 dB to about 40 dB) for the wearable device to perform a specific action. In certain aspects, the at least one processor comprises a whisper keyword detection processor. The whisper keyword detection processor may differentiate the whisper keyword, the regular volume self-voice, and a nearby voice. The whisper keyword detection processor may be capable of distinguishing between differentiate the whisper keyword, a whisper non-keyword, the regular volume self-voice, and a nearby voice. The regular volume self-voice and the nearby voice may be a volume level of greater than about 50 dB, such as about 50 dB to about 90 dB. According to certain aspects, if at block 454, the determination is that the audio is a whisper keyword, the operations 450 may further proceed to block 456. According to certain aspects, if at block 454, the determination is that the audio is a non-whisper keyword, normal volume self-voice, or a nearby voice, the operations 400 may further proceed to block 412.

According to certain aspects, if at block 456, the determination is that the whisper keyword, the operations 450 may further include, at block 458, performing the command of the whisper keyword using the at least one processor. In certain embodiments, the determination at block 456 triggers the performance of the whispered keyword or action. The action may be a command or instruction the user desired to occur. For example, the action may be to enter a desired audio mode. Such audio output modes may include “work mode” to minimize distractions when a user is working, or “public mode” to help increase awareness of the user’s surroundings. In certain aspects, the action may be controlling volume, transport controls, noise cancelling and/or audio pass through, spatial audio settings, feature activation, changing the connected device(s), VPAs, internet searches, content searches, making a call, and/or responding to texts/messages/emails. The commands or instructions and the audio modes referred to herein are merely examples or actions that may be performed, and are not intended to be limiting. Upon performing the action, in certain embodiments, the operations 450 being again at block 402.

According to certain aspects, if at block 405, the determination is that the audio is a non-whisper keyword, normal volume self-voice, the operations 450 may further include, at block 412 to either i) pause or decrease the listening content, or ii) to take no immediate action. The at least one processor may be configured to perform either i) or ii) based on a user’s input preferences. Aspects where the listening content is paused or decreased may relate to managing ambient noise, such as when the user wishes to converse with another person. Upon performing the either i) or ii), in certain embodiments, the operations 450 being again at block 402.

By using the above-described methods to discreetly enable a user to perform a desired command or action of the wearable device without utilizing a wake word, the time-to-action of the command is accelerated. Furthermore, some social issues associated with using a regular voice are removed.

It is noted that the processing related to discreetly enable a user to perform a desired command or action as discussed in aspects of the present disclosure may be performed natively in the wearable device, by the computing device, or a combination thereof.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A wearable audio device, comprising:
a housing;
at least one audio sensor disposed in or on the housing; and
at least one processor configured to:
receive input from the at least one audio sensor;
detect, using the at least one audio sensor, audio from a user of the wearable audio device; and
perform an action in response to determining that i) a volume level of the audio from the user of the wearable audio device is below a threshold and ii) the audio indicates a desired performance of the action.

2. The wearable audio device of claim 1, wherein the volume level is below a normal speaking volume level of the user.

3. The wearable audio device of claim 1, wherein the threshold is at most 50 dB.

4. The wearable audio device of claim 1, wherein one or more audio sensors of the at least one audio sensor is a microphone.

5. The wearable audio device of claim 4, wherein the microphone is a feedback microphone disposed within the housing.

6. The wearable audio device of claim 1, wherein the housing is acoustically coupled with an ear canal of the user to define an acoustic volume, and wherein one or more audio sensors of the at least one audio sensor is included in the acoustic volume.

7. The wearable audio device of claim 1, wherein the at least one processor is further configured to extract the user’s audio from other audio sensed.

8. The wearable audio device of claim 1, wherein the determination triggers the performance of the action.

9. The wearable audio device of claim 1, wherein the audio from the user is a whisper.

10. The wearable audio device of claim 1, wherein determining that the volume level of the audio from the user of the wearable audio device is below the threshold comprises determining that the characteristics of the audio is whisper speech.

11. A method of using a wearable audio device, comprising:
receiving input from at least one audio sensor of a wearable audio device;
detecting, using the at least one audio sensor, audio from a user of the wearable audio device; and
performing an action in response to determining that i) a volume level of the audio from the user of the wearable audio device is below a threshold and ii) the audio indicates a desired performance of the action.

12. The method of claim 11, wherein the audio from the user is a whisper.

13. The method of claim 11, wherein the threshold is at most 50 dB.

14. The method of claim 11, wherein one or more audio sensors of the at least one audio sensor is a microphone.

15. The method of claim 14, wherein the microphone is a feedback microphone disposed within a housing.

16. The method of claim 11, further comprising: defining an acoustic volume using a housing of the wearable audio device, the housing being acoustically coupled with an ear canal of the user, and wherein one or more audio sensors of the at least one audio sensor is included in the acoustic volume.

17. The method of claim 11, further comprising extracting the user’s audio from other audio sensed.

18. The method of claim 11, wherein the determination triggers the performance of the action.

19. The method of claim 11, wherein determining that the volume level of the audio from the user of the wearable audio device is below the threshold comprises determining that the characteristics of the audio is whisper speech.
